(19) United States
(12) Patent Application Publication
(10) Pub. No.: US 2003/0229694 A1
(43) Pub. Date: Dec. 11, 2003

(54) Method of remotely controlling computers via network and architecture thereof

(75) Inventors: Chin-Fu Tsai, Taipei (TW); Richard Tung, Taoyuan Hsien (TW)

Correspondence Address: LOWE HAUPTMAN GOPSTEIN GILMAN & BERNER, LLP, Suite 310, 1700 Diagonal Road, Alexandria, VA, 22314, US

(73) Assignee: QUANTA COMPUTER INC.

(21) Appl. No.: 10/277,929

(22) Filed: Oct. 23, 2002

(30) Foreign Application Priority Data
Jun. 8, 2002 (TW) 91117705

(51) Int. Cl. G06F 15/173

(52) U.S. Cl. 709/224; 709/223

(57) ABSTRACT

A method of remotely controlling computers via a network and an architecture thereof are described. The architecture for remotely controlling computers via a network has a working computer, a network and a remote computer. The working computer has an image display control device, a basic input output system, a processor executed a computer control firmware in front of the operating system, and a working computer network interface controller transferring image packets to the remote computer via the network. The remote computer comprises a remote computer network interface controller to receive the image packets and a remote computer processor executes a monitor program to monitor the images on a display device. The remote computer further comprises an input device to control the working computer directly.

### FIELD OF THE INVENTION

The present invention relates to a method and architecture of remotely controlling computers via a network and especially to a method and architecture of remotely controlling computers without operating systems (OS) via the network.

### BACKGROUND OF THE INVENTION

Information technology and the network industry are highly developed now. People utilize networks to search for information and provide services. Hence, the growing network provides humans with a comfortable and fast environment.

At this time, there is a lot of information to be distributed over the network. Therefore, a network established with only few computers provides insufficient service. Network systems are established with more computers and the computer apparatuses may even be distributed over different places all over the world. The computer apparatuses, such as workstations, servers, database memory, routers, and backup devices, connect with each other via the network so as to provide services.

At this stage, people controlling the server computer via the network have to install a remote control software based on a working operating system (OS). For this management method, an OS, such as Windows operating system, supporting the network must already be installed in the computer. That is to say, if the working computers and the remote computers are using the OS supporting the network and the remote control software, the remote computers can control the working computers via the network.

But if a working computer is using a non-network support OS different from that of the network, such as the disk operating system (DOS), or a working computer has not run yet a network support OS, the remote computer has no way of controlling the working computer via the network. Accordingly, there is a control breach for remotely controlling computers via the network.

### SUMMARY OF THE INVENTION

One object of the present invention is to provide a computer control firmware to remotely control working computers via a network.

Another object of the present invention is to provide a computer control firmware via a network to remotely control working computers before an OS with network support works or while an OS with non-network support is working.

The present invention provides a method of remotely controlling computers via a network. The method comprises the following steps. First, a computer control firmware is executed in a working computer. Then, the working computer connects to a remote computer via the network. The computer control firmware gets image data of the working computer and transforms the same into network packets. The network transmits the network packets to the remote computer. A monitor program is utilized to monitor the image data on the remote computer. The remote computer also transmits network packets to the working computer via the network. The computer control firmware transforms the network packets into commands and information. Finally, the working computer executes the commands.

The working computer and remote computer are server computers or personal computers. The network packets are transmission control protocol/internet protocol (TCP/IP) packets. The monitor program is a terminal simulation software or an internet explorer software. The computer control firmware can reboot or reset settings of a basic input output system (BIOS) of the working computer according to requests from the remote computer.

Another aspect of the present invention provides an architecture for remotely controlling computers via a network. The architecture comprises a working computer, a network, and a remote computer. The working computer further comprises a display controller with an image memory to store image data of the working computer; a basic input output system (BIOS) connecting the display controller to catch the image data from the image memory; a working computer processor connecting the basic input output system; and a working computer network interface controller connecting the working computer processor to transmit the working computer network packets. The working computer processor executes a computer control firmware to transform the image data caught by the basic input output system into working computer network packets. A remote computer further comprises a remote computer network interface controller connecting the network to get the working computer network packets via the network; a remote computer processor connecting the remote computer network interface controller and executing a monitor program; and a display device connecting the remote computer processor to display the image data thereon.

The remote computer further comprises a remote computer input device to input commands and information on the remote computer. The remote computer processor transforms the commands and information into network packets, such as the TCP/IP packets. The remote computer network packets are transmitted to the working computer processor via the remote computer network interface controller, the network, and the working computer network interface controller. The working computer processor changes back the network packets to the commands and information. The working computer executes the commands. The computer control firmware can reboot and reset settings of basic input output system (BIOS) of the working computer according to requests from the remote computer. The working computer and the remote computer comprise server computers or personal computers. The monitor program comprises a terminal simulation software or an internet search software. The remote computer further utilizes the network to control a plurality of computers with the computer control firmware.

The working computer according to the present invention does not need to run any OS and the working computer can be controlled by a remote computer. Further, the working computer with the computer control firmware can be remotely controlled by a remote computer, and can even reboot or reset the BIOS setting by the remote computer. The working computer further comprises a console redirection capability. The working computer redirects information to NIC and then transmits to the remote computer via the network directly. Therefore, the working computer does not need to use a series port or modem for transmission. Hence, the present invention can utilize any computer in the network to control the working computer of the present invention.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is an architecture of remotely controlling computers via a network according to the present invention; and

FIG. 2 is a flowchart outlining a process of the remotely controlling computers via a network according to the present invention.

### DETAILED DESCRIPTION OF THE PREFERRED EMBODIMENT

The following description is the best presently contemplated mode of carrying out the present invention. This description is not to be taken in a limiting sense but is made merely for the purpose of describing the general principles of the invention. The scope of the invention should be determined by referencing the appended claims.

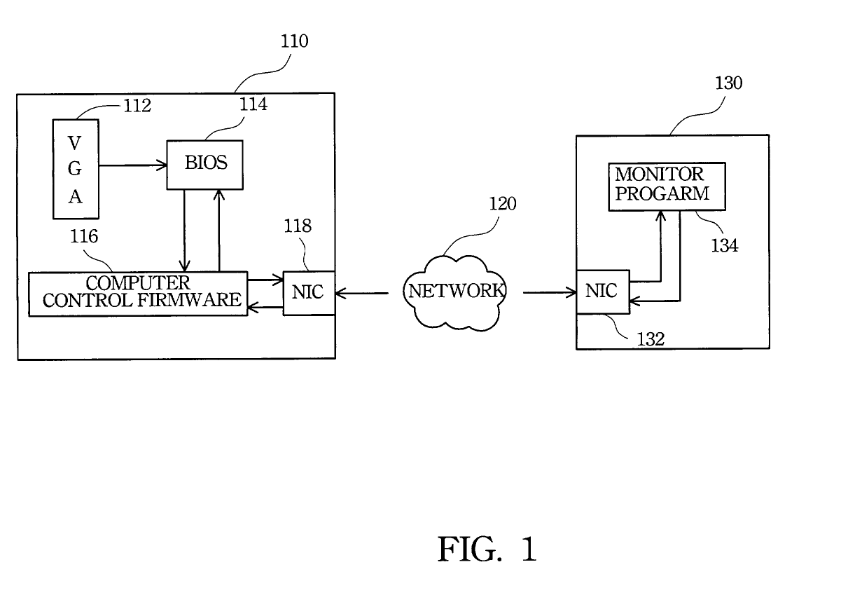

FIG. 1 is an architecture for remotely controlling computers via a network according to the present invention. The architecture of remotely controlling computers has a working computer 110, a network 120, and a remote computer 130. The working computer 110 comprises a display card 112, such as a VGA card, for controlling the image display, a basic input output system (BIOS) 114, a computer control firmware 116, and a network interface controller (NIC) 118. The computer control firmware 116 is running before the working computer 110 begins to work with an operating system. The remote computer 130 comprises a network interface controller (NIC) 132 and a monitor program 134.

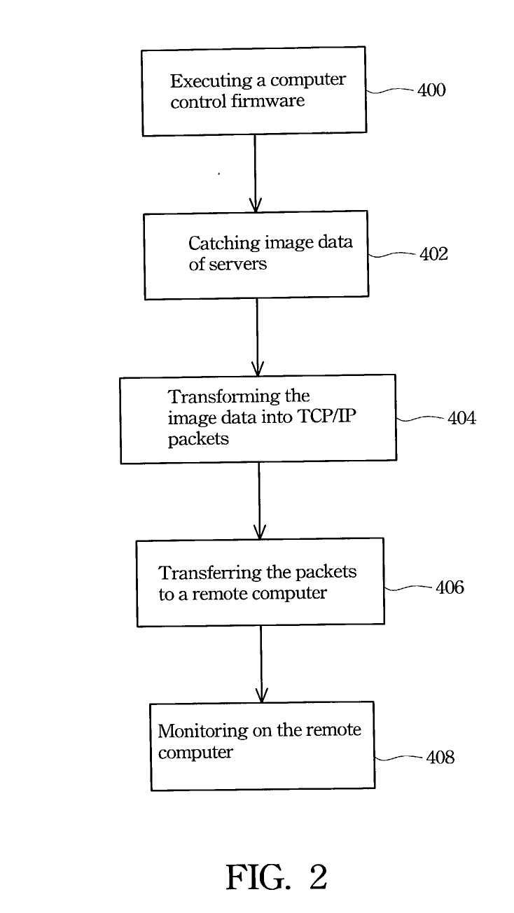

FIG. 2 is flowchart outlining a process for remotely controlling computers via a network according to the present invention. Referring to FIG. 1 and FIG. 2 simultaneously, the present invention is described with the process of FIG. 2 and an auxiliary description with the architecture of FIG. 1.

First, step 400 is to execute a computer control firmware 116 as the working computer 110 according to the present invention turns on. The computer control firmware 116 has the capability of receiving and processing image data caught by the BIOS 114 on the motherboard of the working computer 110 from the display card 112.

At this moment, the process goes to step 402 and step 404. At step 402, the BIOS 114 catches the image data from the memory of the display card 112 of the working computer 110, such as a server computer. The image data is transferred to the computer control firmware 116 by way of the input or output port of the BIOS 114. In step 404, the computer control firmware 116 transforms the image data to transmission control protocol/internet protocol (TCP/IP) packets according to the TCP/IP protocol.

In step 406, the present invention utilizes the NIC 118, network 120, and NIC 132 of the remote computer 130 to transfer the TCP/IP packets to the remote computer 130. In step 408, the remote computer 130 runs a monitor program 134 to monitor instantly the TCP/IP packets received by the NIC 132. The monitor program 134 is a software with a terminal simulation capability or a software of the internet explorer. By way of the network 120 transmitting the packets and connecting the computer control firmware 116, the working computer 130 can display the image data synchronously. The server manager operating the remote computer 130 can control the working computer 110 with any input device of the remote computer 130. The packets of commands and information are delivered to the computer control firmware 116 of the working computer 110. The computer control firmware 116 transforms the packets to commands and information of the working computer 110 to control the working computer 110 through the BIOS 114.

Hence, the architecture for remotely controlling computers according to the present invention can control the working computer via network by a remote computer. The working computer does not need to run any OS with network support capability. The working computer with the computer control firmware of the present invention works in a DOS or Linux environment, text-only mode environment. Further, the server computer with the computer control firmware can be remotely controlled by a remote computer, and can even reboot or reset the BIOS setting with the remote computer. The present invention further utilizes the secure socket layer technology to guarantee the data safety and the data source identification. The above description is a preferred embodiment, and is not limiting of the scope of the present invention. The remote computer of the present invention can further be connected to a plurality of working computers to control remotely the working computers synchronously. The working computer and the remote computer comprise server computers or personal computers.

The method and architecture of remotely controlling computers according to the present invention further comprises a console redirection capability. The console redirection capability according to the present invention redirects information to NIC and then transmits to the remote computer via the network directly. The working computer does not need to use the series port or modem for transmission. The present invention can reset the BIOS setting directly and reboot the working computer; the user can use any remote computer connected to the network to control the working computer from any place. That is to say, the working computer can be controlled by a remote computer in any place, very close or very far, when the working computer uses the computer control firmware according to the present invention and is connected to the network. In particular, the working computer can be controlled by the remote computer before or after the working computer is running an OS and whether or not the OS thereof is the network-supporting OS. Therefore, even if the working computer has no keyboard or mouse, the remote computer can utilize the keyboard or mouse thereof to control the working computer and execute programs on the working computer to solve the working computer's problem.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A method of remotely controlling computers via a network, the method comprising:
executing a computer control firmware in a working computer;
connecting a remote computer to the working computer via the network;
getting an image data from the working computer;
transforming the image data into working computer network packets by the computer control firmware;
transmitting the working computer network packets to the remote computer via the network;
monitoring the image data on the remote computer by a monitor program;
transmitting remote computer network packets to the working computer via the network;
transforming the remote computer network packets into commands and information by the computer control firmware; and
executing the commands in the working computer.

2. The method of claim 1, wherein the working computer comprises a server computer.

3. The method of claim 1, wherein the working computer comprises a personal computer.

4. The method of claim 1, wherein the working computer network packets comprise transmission control protocol/internet protocol (TCP/IP) packets.

5. The method of claim 1, wherein the remote computer network packets comprise transmission control protocol/internet protocol (TCP/IP) packets.

6. The method of claim 1, wherein the remote computer comprises a server.

7. The method of claim 1, wherein the remote computer comprises a personal computer.

8. The method of claim 1, wherein the monitor program comprises a terminal simulation software.

9. The method of claim 1, wherein the monitor program comprises a software of an internet explorer.

10. The method of claim 1, wherein the computer control firmware reboots the working computer according to a request of the remote computer.

11. The method of claim 1, wherein the computer control firmware resets settings of basic input output system (BIOS) of the working computer according to a request of the remote computer.

12. The method of claim 1, wherein the remote computer further utilizes the network to control a plurality of computers with the computer control firmware.

13. An architecture for remotely controlling computers via a network, the architecture comprising:
a working computer comprising:
a display controller with an image memory to store image data of the working computer;
a basic input output system (BIOS) connecting the display controller to capture the image data from the image memory;
a working computer processor connecting the basic input output system, wherein the working computer processor executes a computer control firmware to transform the image data caught by the basic input output system into working computer network packets; and
a working computer network interface controller connected to the working computer processor to transmit the working computer network packets;
a network connecting the working computer network interface controller; and
a remote computer comprising:
a remote computer network interface controller connecting the network to get the working computer network packets via the network;
a remote computer processor connecting the remote computer network interface controller and executing a monitor program; and
a display device connecting the remote computer processor to display the image data thereon.

14. The architecture of claim 13, the remote computer further comprising a remote computer input device to input commands and information on the remote computer, wherein the remote computer processor transforms into remote computer network packets, the remote computer network packets are transmitted to the working computer processor via the remote computer network interface controller, the network, and the working computer network interface controller, the working computer processor transforms the remote computer network packets into commands and information for the working computer, and the working computer executed the commands to control the working computer through the basic input output system.

15. The architecture of claim 14, wherein the computer control firmware reboots the working computer according to a request of the remote computer.

16. The architecture of claim 14, wherein the computer control firmware resets settings of the basic input output system (BIOS) of the working computer according to a request of the remote computer.

17. The architecture of claim 13, wherein the remote computer network packets comprise transmission control protocol/internet protocol (TCP/IP) packets.

18. The architecture of claim 13, wherein the monitor program comprises a terminal simulation software.

19. The architecture of claim 13, wherein the monitor program comprises a software of an internet explorer.

20. The architecture of claim 13, wherein the remote computer further utilizes the network to control a plurality of computers with the computer control firmware.
